(19) United States
(12) Patent Application Publication
(10) Pub. No.: US 2021/0079763 A1
(43) Pub. Date: Mar. 18, 2021

(54) CONTINUOUS INSTALLATION OF MULTIPLE SUBSEA FUNCTION LINES WITH IN-LINE TEES

(71) Applicant: Vetco Gray Scandinavia AS, Sandvika (NO)

(72) Inventors: Mohammad Hasan ALI, Sandvika (NO); Knut Arne SAETRE, Sandvika (NO); Hans Kristian SUNDT, Oslo (NO); Paul WHITE, Aberdeen Aberdeenshire (GB)

(21) Appl. No.: 16/954,030

(22) PCT Filed: Dec. 7, 2018
(86) PCT No.: PCT/EP2018/083951

§ 371 Date: Jun. 15, 2020

(30) Foreign Application Priority Data
Dec. 15, 2017 (NO) 20171995

(51) Int. Cl. E21B 43/013; F16L 1/16

(52) U.S. Cl. CPC E21B 43/013; F16L 1/16

(57) ABSTRACT

The invention relates to subsea installations 1 for offshore production of oil and gas, and more particularly to seabed assemblies, systems and methods for continuous installation of multiple subsea functional lines with connected in-line modules 70/assemblies.

The invention relates to subsea installations for offshore production of oil and/or gas, and more particularly to subsea assemblies, systems and methods for continuous installation of multiple subsea functional lines with connected in-line modules on a common host.

U.S. Pat. No. 8,950,497 B2 relates to an integrated termination assembly comprising a rigid support structure and a first functional line and a second functional line terminating at the rigid support structure and having a different function than the first functional line. The first and second functional lines can be production flowlines, umbilicals, electrical cables, hydraulic fluid lines, chemical injection lines, fiber-optic cables, gas injection lines, water injection lines, pneumatic lines, or combinations thereof.

WO 2017/174968 A1 concerns a pipeline integrated manifold.

A subsea manifold is a flow-routing subsea hardware (subsea flow router) that connects between several subsea trees and flowlines. It is used to optimize the subsea layout arrangement and to reduce the quantity of risers connected to a platform. If connected to dual flowlines, the manifold can typically accommodate pigging and can have the capability of routing production from a particular tree to a particular flowline. Another manifold is the so-called PLEM, a pipeline end manifold.

A production line is a production pipeline used for recovery of oil and/or gas from a subsea well. In subsea installations, there can be a main production line and possibly at least one branch production line.

A subsea umbilical is an assembly of hydraulic hoses, which can also include electrical cables and/or optic fibers, and being used to control subsea structures from e.g. an offshore platform or a floating vessel. The subsea umbilical is an essential part of a subsea production system, without which sustained economical subsea petroleum production is not possible.

A Christmas tree (XT) is an assembly of valves, spools and fittings being used in connection with different types of wells, such as e.g. an oil well, gas well, water injection well, water disposal well, gas injection well, condensate well and other types of wells.

Jumpers are pipe connectors that are used to connect two subsea components in order to transport production fluid therebetween. Jumpers can for example connect between manifold systems and wells, X-mas trees and manifolds, one manifold and another manifold, sleds to wells and/or manifolds to sleds, wherein the sleds can range in complexity from a single hub with manual isolation valve to multiple hubs with actuated valves, chemical injection, pig launching capabilities and more. There are different types of subsea jumpers, such as e.g. well jumpers, hydraulic/electric jumpers, electric/fiber optic jumpers, etc.

A subsea umbilical termination assembly (UTA) is a multiplexed electrohydraulic system allowing many subsea control modules (SCMs) to be connected to the same communications, electrical and hydraulic supply lines. The UTAs terminate umbilical lines and provide one or more connections for hydraulic, chemical, electrical and fiber optic services. The result is that many wells can be controlled via one umbilical. From the UTA, the connections to the individual wells and SCMs are made with jumper assemblies. Another termination assembly is the so-called PLET, a pipeline end termination.

The UTAs can be designed as either mudmat based (i.e. sitting on top of a mud pad), stab-and-hinge or vertical and can be designed and customized to fit a desired purpose.

A subsea distribution unit (SDU), particularly designed for the purpose of the invention, can be a multiplexed electrohydraulic system allowing many subsea control modules (SCMs) to be connected to the same communication, electrical and hydraulic supply line. The SDU module distributes, from one umbilical line, several hydraulic, chemical and electric/fiber optic service lines via one or more connections. The result is that many wells can be controlled via only one umbilical. From the SDU, the connections to the individual wells and the SCMs are made with jumper assemblies. Traditional SDUs are connector(s) to UTA(s) via intermediate hydraulic and electrical/optical jumper assemblies, or alternatively connector(s) directly connected to UTA(s) via multi-bore hub tie-in connection(s).

A tie-back is a subsea connection between a new oil and/or gas discovery and an existing production facility. It can also be a connection of additional risers to a floating vessel or a platform.

An in-line Tee (ILT) is an integrated equipment package that creates a branched line tie-in point along a pipeline. By creating a tee along the pipeline, an operator can plan for tie-in points to fit future expansion plans. The ILT can divert flow of fluid from/to a main pipeline to/from one or more branch lines.

An ILT system can be integrated into a skid with necessary valves, lifting and support structures, mudmats and piping components. This facilitates simple installation into the line during launching and pipe-lay operations.

Future expansions can be attached to the in-line Tee by means of a collet or clamp connector that can be connected to a tie-in hub which will be a part of the in-line Tee equipment package.

Conventional subsea layout arrangements have independent in-line Tees (ILTs) and subsea umbilical termination assemblies (UTAs). In such subsea layouts usually there are separate UTAs with bridging jumpers, and thus separate mudmats are being used. There are usually separate main/in-field umbilical installations. In addition, it is often necessary with additional UTA and mudmat installations. All of this leads to expensive distribution hardware.

A drawback of the known prior art techniques is that they are confined to termination structures of the multifunctional lines that limit the use to remote tie-back field with ½ wells and have limited expansion capability. On the other hand, the present invention enables larger field development using in-line modules reaching out to multiple well locations on the seabed in various layout arrangements, such as e.g. production loops, water or gas injection pipelines, gas lift pipelines and service/utility lines.

It is an object of the invention to provide for connection of multiple wells or drill centers, located at far distances, through a common pipeline with an optimized subsea field infrastructure.

Another object of the invention is to provide for continued installation of additional Tees and SDUs e.g. in a single lay operation or in only two lay operations, thereby connecting to multiple wells or drill centers, located at far distances, through a common pipeline.

Yet another object of the invention is to enable subsea developments of large tie-back fields and future expansions thereof.

Yet another object of the invention is to avoid termination of the umbilical in subsea installations with multiple subsea functional lines. This will further reduce the number of terminations and any need of in-field bridging hydraulic and electrical/optical jumpers between multiple terminations.

Yet another object is to enable savings on hardware capital expense (CAPEX) (e.g. ca. 30%) and installation time (e.g. ca. 40%).

Conventionally, in-line Tees / Tee modules are installed separately and independently for each functional line (e.g. production and umbilical). The solution of the present invention will enable continuous and combined installation of at least two subsea functional lines having different functions (e.g. production and controls umbilical) using intermittent in-line Tee assembly (e.g. production branch Tee) and in-line SDU (Subsea Distribution Unit) assembly, which individually or both can be commonly and connectedly or disconnectedly hosted e.g. on a pipeline, on a seabed or on a mudmat.

The industry prior art has either a separate installation of the production and umbilical lines or a bundled installation, where the production pipe is included in the umbilical bundle itself. The present solution will take the benefit of the existing technologies, but will optimize the subsea field layout using common structures instead of separate structures and will thus save cost and installation time.

According to a first aspect of the invention this is achieved with a subsea installation for continuous installation of multiple subsea functional lines with connected in-line modules, wherein an umbilical is not terminated and an in-line Tee module and an in-line SDU module are arranged on a common mudmat.

According to a second aspect of the invention this is achieved with a subsea installation for continuous installation of multiple subsea functional lines with connected in-line modules, wherein a production pipeline hosts both an in-line Tee module and an in-line SDU module, the production pipeline being installed together with an umbilical in a bundle (e.g. piggy back) configuration.

According to a third aspect of the invention, the in-line Tee module and the in-line SDU module can be commonly hosted on the seabed itself, if the seabed rock structure/seabed soil allows/permits that.

The main features of this invention are given in the independent claims. Additional features of the present invention are given in the dependent claims.

A subsea arrangement of the present invention is adapted for continuous installation of multiple subsea functional lines with connected in-line modules. The subsea arrangement comprises a production line and an umbilical line. The production line has a production inflow side and a production outflow side. The umbilical line has a production inflow side and a production outflow side: The subsea arrangement further comprises a common host structure arranged for hosting a combination of an in-line Tee module and an in-line SDU module. The in-line Tee module connected to a single X-mas tree via a well jumper. The in-line SDU module is connected to the X-mas tree via hydraulic/electrical/optical jumpers.

According to one embodiment of the invention, the common host structure can be a common mudmat.

According to another embodiment of the invention, the common host structure can be the production line itself.

According to a further embodiment of the invention and of course if the seabed soil or rock structure allows/permits that, the common host structure can be the seabed itself.

A bracket arrangement for pipeline support can be used to hold the in-line Tee module on the production line when the common host structure is the production line itself.

Another bracket arrangement for pipeline support can be used to hold the in-line SDU module on the production line when the common host structure is the production line itself.

When the common host structure is the production line itself, then the in-line Tee module can further comprise a rotation adjustment mechanism adapted for correction of the position of the in-line Tee module with respect to the pipeline.

When the common host structure is the production line itself, then the in-line SDU module can further comprise another rotation adjustment mechanism adapted for correction of the position of the in-line SDU module with respect to the pipeline.

The in-line Tee module can further comprise a lock-pin arrangement adapted to relieve the stress in a branch Tee piping due to pipeline bending during the installation process.

These and other aspects of the invention are apparent from and will be further elucidated, by way of example(s), with reference to the drawings, wherein:

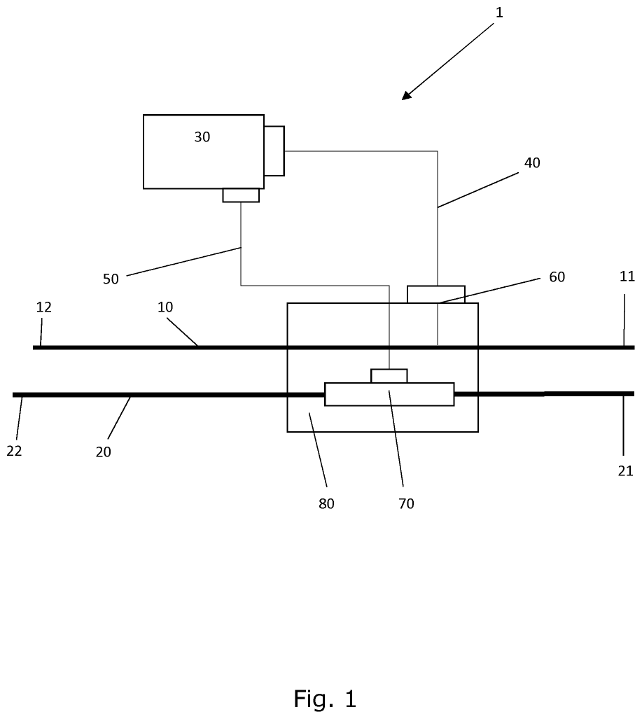

FIG. 1 shows a first layout of a subsea installation according to the invention;

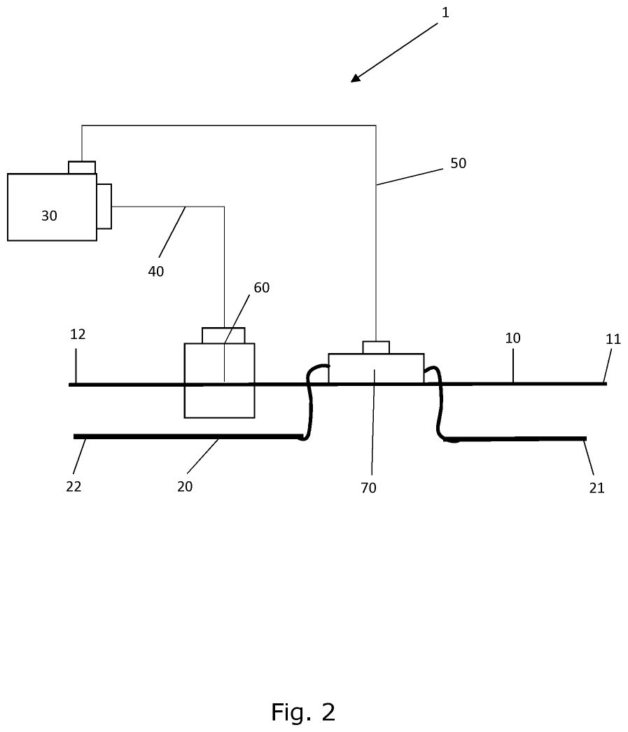

FIG. 2 shows a second layout of a subsea installation according to the invention;

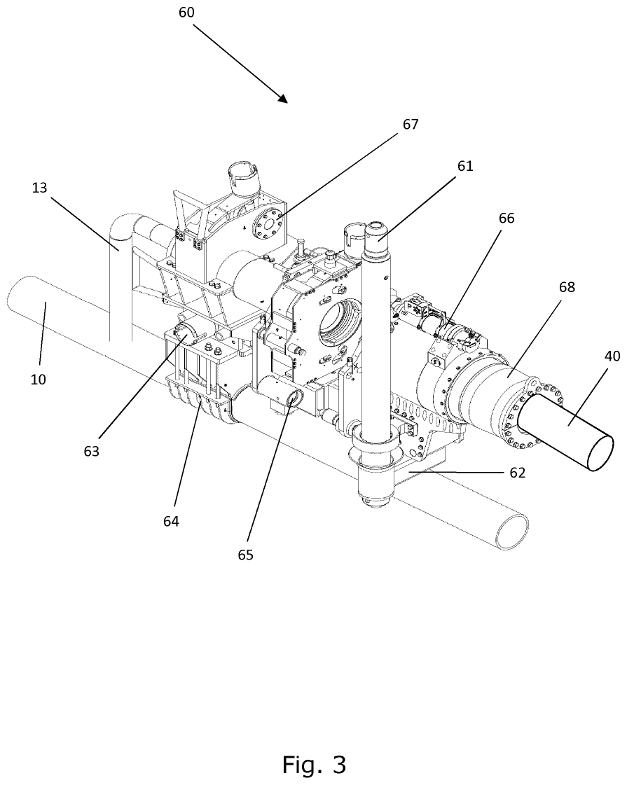

FIG. 3 illustrates an in-line Tee module according to the invention;

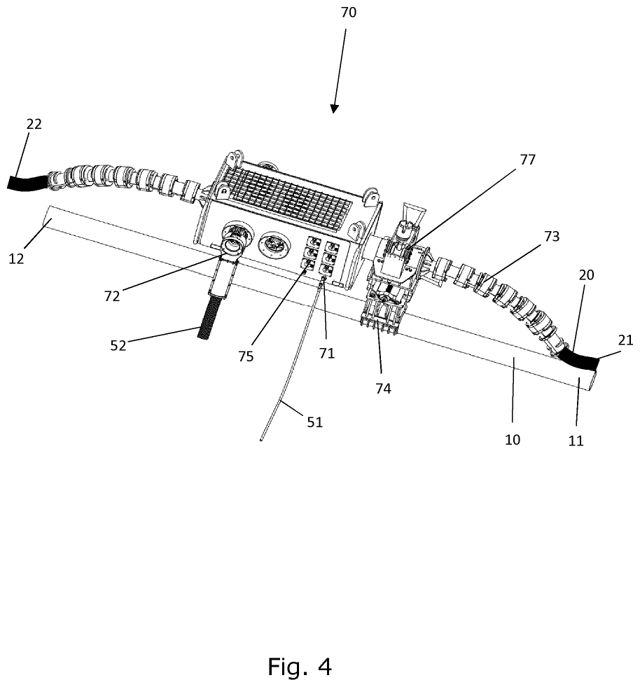

FIG. 4 illustrates an in-line SDU module according to the invention;

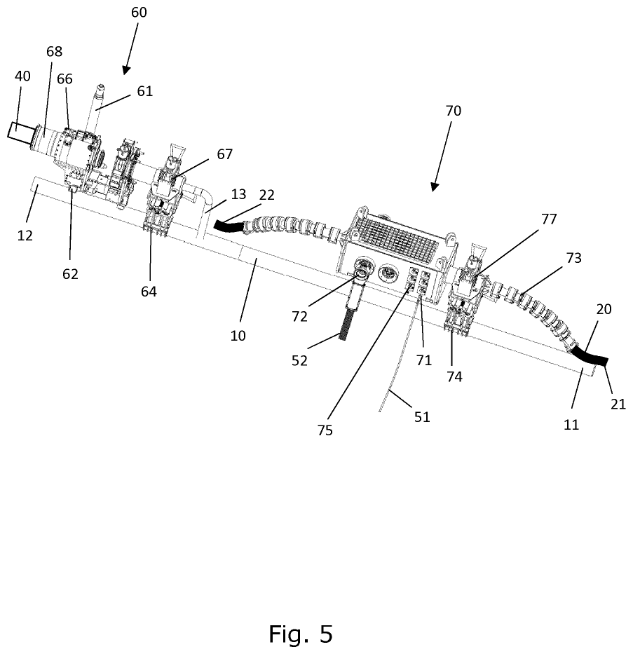

FIG. 5 shows in detail a combination of the in-line Tee module and the in-line SDU module arranged on the production pipeline of the subsea installation according to the second layout of the invention.

FIG. 1 illustrates a subsea arrangement 1 for continuous installation of multiple subsea functional lines with connected in-line modules. The subsea installation comprises a combination of an in-line Tee module and an in-line SDU (Subsea Distribution Unit) module, wherein a production pipeline and an umbilical are installed in a bundle or separately, and the in-line Tee module and the in-line SDU module are hosted on a common mudmat.

The subsea arrangement 1 comprises a production line 10 having a production inflow side 11 and a production outflow side 12, and an unterminated umbilical line 20 having a production inflow side 21 and a production outflow side 22. The subsea arrangement 1 further comprises a common mudmat 80 arranged for hosting an in-line Tee module 60 connected via a well jumper 40 to a single X-mas tree 30, and an in-line SDU module 70 connected via hydraulic/electrical/optical jumpers 50, 51, 52 to the X-mas tree 30.

The production pipeline 10 and the umbilical 20 can be installed in a bundle as e.g. piggy back (in only one installation operation) or can be installed separately (in two separate installation operations for each of the two lines (the production line and the umbilical line)).

This first layout can be suitable for soft soils in e.g. deep waters, where a mudmat would normally be necessary, or alternatively in order to satisfy a desired installation methodology, where a separate installation of each line is preferred due to e.g. vessel restrictions, laying method, etc.

FIG. 2 illustrates another subsea arrangement 1 for continuous installation of multiple subsea functional lines with connected in-line modules. In this embodiment, the subsea installation comprises a combination of an in-line Tee module and an in-line SDU (Subsea Distribution Unit) module according to the invention. However, in this subsea arrangement 1, the production pipeline 10 hosts the in-line SDU 70 and is installed together with the umbilical 20 in a bundle. The in-line SDU module 70 is arranged on the production line 10 by means of a bracket arrangement for pipeline support 74. The in-line Tee module 60 is also hosted on the production pipeline 10. The in-line Tee module 60 is arranged on the production line 10 by means of a bracket arrangement for pipeline support 64. If needed, a separate mudmat (not shown) can be pre-installed.

This second layout can be suitable for hard / rocky soil in e.g. shallow waters, where there would be no need of a mudmat, or in the instance where the seabed is intended to be rock-dumped/prepared in order to allow such an arrangement. Alternatively, a mudmat may also be attached depending on the seabed soil conditions.

In both layouts, an in-line Tee 60 and an in-line SDU (Subsea Distribution Unit) 70 are being combined. They can both or individually be arranged on a common host structure, such as e.g. a common mudmat 80 or a production pipeline 10. The subsea arrangement 1 can be a bundled installation or a separate installation. However, the continuity of the functional lines 10, 20, and particularly of the umbilical line 20, is secured in the present invention (due to the designed SDU module).

FIG. 3 illustrates in detail the in-line Tee module 60 according to the invention. For securing of the installation, the in-line Tee module 60 can comprise an installation guidepost 61 adapted for cooperation with a landing beam 62 having a guidepost receptacle being arranged on the production pipeline 10. In the second layout of the invention, a bracket arrangement 64 for pipeline support can be used in order to hold the in-line Tee module 60 on the production line 10. Optionally, the in-line Tee module 60 can comprise a rotation adjustment mechanism 67 adapted for correction of the position (with ranging approximately ±10-15 degrees, preferably ±5 degrees) of the in-line Tee module 60 with respect to the pipeline 10. A lock-pin arrangement 63 of the in-line Tee module 60 can be used to relieve the stress in a branch Tee piping 13 that may occur due to pipeline bending during installation. An inboard porch assembly 65 of the in-line Tee module 60 has a female hub with a clamp connector attached to the branch Tee piping 13. The inboard porch assembly 65 can be used to enable tie-in of the jumper 40 connecting to the XT 30. A stroking tool 66 of the in-line Tee module 60 can be used in order to do the stroking operation once the outboard termination assembly 68 has landed on the landing beam 62 in order to establish connection with the inboard porch assembly 65.

FIG. 4 illustrates in detail the in-line SDU (Subsea Distribution Unit) 70 according to the invention. In the second layout of the invention, a bracket arrangement 74 for pipeline support can be used in order to hold the in-line SDU module 70 on the production line 10. The SDU module 70 is designed in such a manner that it allows for continuous installation of the umbilical line 20. Bend restrictors 73 can be used in order to secure the umbilical's 20 inflow 21 and outflow 22 sides from being damaged. Optionally, the in-line SDU module 70 can comprise a rotation adjustment mechanism 77 adapted for correction of the position (with ranging approximately ±10-15 degrees, preferably ±5 degrees) of the in-line SDU module 70 with respect to the pipeline 10. An electrical/optical jumper 51 connects the tree 30 to the in-line SDU module 70 by means of electrical/optical connectors 71. A hydraulic jumper 52 connects the tree 30 to the in-line SDU module 70 by means of e.g. MQC (Multi Quick Coupler) stab-plate connectors 72. The SDU module can additionally have ROV isolation valves 75 for isolation of chemical/hydraulic lines during installation and/or intervention operations. This means that these valves are closed under the mentioned operations. The valves 75 shall be held open during a normal production operation. ROV(s) is(are) usually used to open and/or close these valves 75.

FIG. 5 shows in detail a combination of the in-line Tee module 60 and the in-line SDU module 60 being commonly arranged on the production pipeline 10 of the subsea installation 1 according to the second layout of the invention.

Additional modifications, alterations and adaptations of the present invention will suggest themselves to those skilled in the art without departing from the scope of the invention as expressed and stated in the following patent claims.

### LIST OF ELEMENTS

1. Subsea arrangement
10. Production line
11. Production inflow side
12. Production outflow side
13. Branch Tee pipe (side)
20. Umbilical/umbilical line
21. Umbilical inflow side
22. Umbilical outflow side
30. X-mas tree
40. Well jumper
50. Hydraulic/electric jumpers
51. Electrical/optical jumper
52. Hydraulic jumper
60. In-line Tee (module)
61. Installation guidepost
62. Landing beam with guidepost receptacle
63. Lock-pin arrangement
64. Bracket arrangement for pipeline support
65. Inboard porch assembly
66. Stroking tool
67. Rotation adjustment mechanism
68. Outboard termination assembly
70. In-line SDU
71. Electrical/optical connectors
72. MQC stab-plate connectors
73. Bend restrictor
74. Bracket arrangement for pipeline support
75. ROV isolation valves
77. Rotation adjustment mechanism
80. Mudmat

1. A subsea arrangement (1) adapted for continuous installation of multiple subsea functional lines with connected in-line modules (60, 70), the subsea arrangement (1) comprising a production line (10) having a production inflow side (11) and a production outflow side (12), and an umbilical line (20) having a production inflow side (21) and a production outflow side (22), wherein the subsea arrangement (1) further comprises a common host structure arranged for hosting a combination of an in-line Tee module (60) connected via a well jumper (40) to a single X-mas tree (30) and an in-line SDU module (70) connected via hydraulic/electrical/optical jumpers (50, 51, 52) to the X-mas tree (30).

2. The subsea arrangement (1) according to claim 1, wherein the common host structure is a common mudmat (80).

3. The subsea arrangement (1) according to claim 1, wherein the common host structure is a seabed itself.

4. The subsea arrangement (1) according to claim 1, wherein the common host structure is the production line (10) itself.

5. The subsea arrangement (1) according to claim 4, wherein a bracket arrangement (64) for pipeline support is used in order to hold the in-line Tee module (60) on the production line (10).

6. The subsea arrangement (1) according to claim 4, wherein a bracket arrangement (74) for pipeline support is used in order to hold the in-line SDU module (70) on the production line (10).

7. The subsea arrangement (1) according to claim 4, wherein the in-line Tee module (60) further comprises a rotation adjustment mechanism (67) adapted for correction of the position of the in-line Tee module (60) with respect to the pipeline (10).

8. The subsea arrangement (1) according to claim 4, wherein the in-line SDU module (70) further comprises a rotation adjustment mechanism (77) adapted for correction of the position of the in-line SDU module (70) with respect to the pipeline (10).

9. The subsea arrangement (1) according to claim 1, wherein the in-line Tee module (60) comprises a lock-pin arrangement (63) adapted to relieve the stress in a branch Tee piping (13) due to pipeline bending during installation.
